(19) United States
(12) Patent Application Publication
(10) Pub. No.: US 2012/0292837 A1
(43) Pub. Date: Nov. 22, 2012

(54) HYDRAULIC MOUNT

(75) Inventors: Werner Hettler, Mannheim (DE); Herbert Otto Guthier, Wald Michelbach (DE)

(73) Assignee: Carl Freudenberg KG, Weinheim (DE)

(21) Appl. No.: 13/474,758

(22) Filed: May 18, 2012

(30) Foreign Application Priority Data
May 19, 2011 (DE) 10 2011 102 076.8

(51) Int. Cl. F16F 13/08

(52) U.S. Cl. 267/140.11

(57) ABSTRACT

A hydraulic mount includes a support bearing and a seat. At least a first and a second partial spring element are each formed from an elastomeric material and connected to each other via an intermediate ring. The spring elements support the support bearing and the seat on each other and have essentially a truncated cone-like shape. An expansion chamber and a compensation chamber are each filled with a first damping fluid. The chambers are physically separated from each other, in an axial direction, by a partition and are connected to each other, in a manner that allows passage of liquid, by a first damper configured to dampen vibrations introduced in the axial direction. A second damper is disposed in the expansion chamber and configured to dampen vibrations introduced in a radial direction. The intermediate ring and the second damper transition from one to the other.

### CROSS-REFERENCE TO PRIOR APPLICATION

Priority is claimed to German Patent Application No. DE. 10 2011 102 076.8, filed on May 19, 2011, the entire disclosure of which is hereby incorporated by reference herein.

### FIELD

An embodiment of the invention relates to a hydraulic mount, comprising a support bearing and a seat, which are supported on each other by a spring element that is shaped essentially like a truncated cone and made of elastomeric material, and it also relates to an expansion chamber and a compensation chamber that are each filled with damping fluid and physically separated from each other by a partition in the axial direction, and that in a manner that allows the passage of liquid—are connected by a first damper for damping axially introduced vibrations.

### BACKGROUND

A hydraulic mount is generally known, for example, from German laid-open document DE 100 37 954 A1. In the prior-art hydraulic mount, the support bearing is configured as a first inner supporting element that is surrounded by an outer second supporting element situated at a radial distance, whereby the first and the second supporting elements are connected by a first spring element and by a second spring element. The first spring element and the second spring element delimit at least two chambers that are filled with damping fluid, that are arranged perpendicular to the axis of the hydraulic mount extending in the axial direction, that are arranged essentially opposite from each other in the radial direction, and that—in a manner that allows the passage of liquid—are connected to each other by a second damping opening. Consequently, the prior-art hydraulic mount comprises two dampers, whereby one damper corresponds to that of a conventional hydraulic mount in which, for damping purposes in the axially extending main direction of action, damping fluid is transferred from the expansion chamber through the first damper into the compensation chamber and back again. In order to damp vibrations that are introduced into the hydraulic mount in the radial direction, perpendicular to the main direction of action, the second damper is physically arranged axially adjacent to the first damper, whereby the spring element that is shaped like a truncated cone separates the two dampers from each other on their sides facing each other axially. The prior-art hydraulic mount has large dimensions in the axial direction, which is why it requires a correspondingly large installation space and, due to this design, a relatively large amount of material is needed to manufacture the prior-art hydraulic mount.

### SUMMARY

In an embodiment, the present invention provides a hydraulic mount including a support bearing and a seat. At least a first and a second partial spring element are each formed from an elastomeric material and connected to each other via an intermediate ring. The spring elements support the support bearing and the seat on each other and have essentially a truncated cone-like shape. An expansion chamber and a compensation chamber are each filled with a first damping fluid. The chambers are physically separated from each other, in an axial direction, by a partition and are connected to each other, in a manner that allows passage of liquid, by a first damper configured to dampen vibrations introduced in the axial direction. A second damper is disposed in the expansion chamber and configured to dampen vibrations introduced in a radial direction. The intermediate ring and the second damper transition from one to the other.

### BRIEF DESCRIPTION OF THE DRAWINGS

The present invention will be described even greater detail below based on the exemplary, schematic figures. The invention is not limited to the exemplary embodiments. Other features and advantages of various embodiments of the present invention will become apparent by reading the following detailed description with reference to the attached drawings which illustrate the following:

FIG. 1 a first embodiment of a hydraulic mount in a lengthwise sectional view, in which the intermediate ring and the second damper are configured so as to make a transition from one to the other as a single piece,

FIG. 2 a cross section through the hydraulic mount of FIG. 1,

FIG. 3 a second embodiment of a hydraulic mount, similar to the hydraulic mount of FIG. 1, with a differently designed second damper,

FIG. 4 a cross section through the hydraulic mount of FIG. 3,

FIG. 5 a third embodiment of a hydraulic mount in which the damping channel of the second damper is configured so as to be helical,

FIG. 6 a cross section through the hydraulic mount of FIG. 5,

FIG. 7 a fourth embodiment of a hydraulic mount in which the second damper comprises two damping channels that are separated from each other so as to be fluid-tight,

FIG. 8 a cross section through the hydraulic mount of FIG. 7,

FIG. 9 a fifth embodiment of a hydraulic mount that additionally has an absorption function in the axial direction,

FIG. 10 a cross section through the hydraulic mount of FIG. 9,

FIG. 11 a sixth embodiment of a hydraulic mount, similar to the hydraulic mount of FIG. 9, comprising another axial absorber,

FIG. 12 a cross section through the hydraulic mount of FIG. 11,

FIG. 13 a seventh embodiment of a hydraulic mount with a two-part intermediate ring and a two-part spring element,

FIG. 14 a cross section through the hydraulic mount of FIG. 13,

FIG. 15 an eighth embodiment of a hydraulic mount in which the second damper additionally has a membrane for uncoupling higher-frequency low-amplitude vibrations,

FIG. 16 a top view of the hydraulic mount of FIG. 15,

FIG. 17 a ninth embodiment of a hydraulic mount in which the intermediate ring has a holding means configured as a holding claw for purposes of attaching the second damper,

FIG. 18 a cross section through the hydraulic mount of FIG. 17,

FIG. 19 a tenth embodiment of the hydraulic mount, similar to the hydraulic mount of FIG. 3, whereby the support bearing and a catch are configured so as to make a transition from one to the other as a single piece, and

FIG. 20 a cross section through the hydraulic mount of FIG. 19,

Reference numerals not shown in latter Figures can be gleaned by reference to earlier figures denoting like or similar parts.

### DETAILED DESCRIPTION

In an embodiment, the invention, compared to the prior-art hydraulic mount, provides a hydraulic mount that has multi-axial damping capacity while having a compact design, especially in the axial direction. It should be possible to manufacture the hydraulic mount inexpensively with a small amount of material.

In an embodiment, the invention provides that the spring element comprises at least two partial spring elements that are connected to each other by an intermediate ring, whereby a second damper is arranged in the expansion chamber in order to damp vibrations introduced in the radial direction, and whereby the intermediate ring and the second damper are configured so as to make a transition from one to the other.

With such an embodiment design, it is advantageous if the hydraulic mount according to an embodiment of the invention, in terms of its dimensions and consequently in terms of the installation space needed, practically does not differ from conventional hydraulic mounts that effectuate damping exclusively in the main axial direction of action.

In the hydraulic mount according to an embodiment of the invention, the second damper is integrated into the expansion chamber. In spite of the compact dimensions, especially in the axial direction, the hydraulic mount has multi-axial damping capacity. The first damper damps vibrations introduced into the hydraulic mount in the main direction of action extending in the axial direction, whereby this damping is effectuated in that, when vibrations are introduced axially into the hydraulic mount, the damping fluid is transferred from the expansion chamber through the first damper and through the partition into the compensation chamber and back again.

In contrast, if vibrations are introduced into the hydraulic mount in the radial direction, the second damper is operational. The second damper preferably comprises two or four expansion chambers that form one or two pairs of chambers. To the extent that damping fluid is displaced out of one chamber of a pair of chambers, the other chamber takes up the displaced damping fluid. As a result, the second damper is highly damping efficient.

The second damper is preferably filled with damping fluid and is closed off so as to be fluid-tight with respect to the expansion chamber during the proper use of the hydraulic mount. The two dampers are thus separated from each other in terms of their function.

Pressure compensation is possible in the case of a high internal pressure in the hydraulic mount, that is to say, an abrupt deviation. Due to this valve function, damage to the hydraulic mount by an impermissibly high internal pressure is avoided.

According to a first embodiment, the intermediate ring can have a holding means that is arranged on its inner circumferential side in the expansion chamber and that is connected to the second damper. Due to such an embodiment, a structurally simple attachment of the second damper in the expansion chamber is possible. Already with conventional hydraulic mounts, which only allow damping of vibrations introduced axially in the main direction of action, the use of intermediate rings that divide the spring element into two partial spring elements is known so that, if necessary, the properties of use of the hydraulic mount can be better adapted to the individual application case. These intermediate rings, however, have no other function than to separate the two partial spring elements from each other in order to achieve the desired spring properties.

The holding means can be configured as a holding claw that is positively or non-positively connected to the second damper. Here, it is advantageous that, like a modular system consisting of several second dampers, the suitable one can be selected and attached in the expansion chamber of the hydraulic mount by means of the holding claw.

According to another embodiment, it can be provided for the intermediate ring and the second damper to be configured so as to make a transition from one to the other as a single piece. Here, it is advantageous that a holding means and a separately produced second damper, as described above, are not needed. The second damper forms an integral part of the intermediate ring. As a result, the hydraulic mount has an especially simple structure with very few parts, and the risk of incorrect assembly is kept to a minimum.

The second damper can comprise a channel part and a closure part, whereby the channel part and the closure part delimit at least one damping channel for damping radially introduced vibrations. In the flow direction, the damping channel can open up on both sides into an expansion chamber that is situated in the second damper and that is filled with the damping fluid, whereby, in order to damp radially introduced vibrations, the damping fluid present in the damping channel is moved back and forth. As a result, greater damping efficiency is achieved.

The damping channel can be configured so as to be helical and bi-level in the axial direction. Here, it is advantageous for the damping channel to be especially long, as a result of which a large mass of damping fluid is contained in the damping channel, and low-frequency high-amplitude vibrations can be damped especially effectively by the large mass of damping fluid that moves back and forth.

According to another embodiment, it can be provided for the second damper to comprise two damping channels that are separated from each other so as to be fluid-tight and that are arranged adjacent to each other in the axial direction. As a result, the second damper has four expansion chambers. With such an embodiment, it is advantageous that each of the damping channels can connect two fluid chambers that are radially opposite from each other, whereby the fluid chambers of the one channel are arranged offset, for example, by 90° relative to the fluid chambers of the other channel. Consequently, it is possible to damp vibrations introduced into the hydraulic mount in different directions, for instance, vibrations introduced into the hydraulic mount radially in the driving direction as well as vibrations introduced into the hydraulic mount radially perpendicular thereto.

The support bearing can be configured so as to be essentially T-shaped as seen in the lengthwise section of the hydraulic mount. The support bearing can comprise an attachment means that is arranged in the center. Such an attachment means can be in the form of, for example, a threaded bolt that projects over the essentially disk-shaped top of the support bearing.

According to another embodiment, the attachment means can be in form of a threaded blind hole that is delimited by the disk-shaped top of the support bearing and by the axial projection.

The axial projection of the support bearing is moveable in the radial direction relative to the second damper and, as a result, it activates the second damper when radial vibrations are introduced into the hydraulic mount. When the axial projection of the support bearing makes a radial movement relative to the second damper, the damping fluid inside the chambers is moved back and forth via the damping channel(s) of the second damper. This damps the vibrations introduced in the radial direction.

The support bearing can comprise a catch extending axially in the direction of the expansion chamber, whereby the support bearing and the catch together have an axial extension that corresponds essentially to the axial extension of the second damper. Due to such an embodiment, the second damper can be activated especially accurately. The axial projection of the support bearing and the catch are each made of a tough-hard material, for example, a metallic material.

With an eye towards achieving the simplest and most cost-effective production of the hydraulic mount possible, it can be provided that the support bearing and the catch are configured so as to make a transition from one to the other as a single piece.

In contrast to this, it is also possible for the catch to be manufactured separately and to be preferably connected coaxially to the support bearing. As a result, different catches can be combined with different support bearings and different spring elements in order to allow the best possible adaptation of the properties of use of the hydraulic mount to each individual application case.

For some application cases, it is advantageous for the hydraulic mount to also have an absorption function in addition to the damping in the axial and radial directions.

For this purpose, it can be provided for an absorption channel to be arranged in the expansion chamber. The absorption channel is dimensioned in such a way that, in order to absorb idling vibrations of an internal combustion engine, the damping fluid situated inside the absorption channel moves in the axial direction back and forth out of the expansion chamber so as to be phase-shifted, preferably in the opposite phase. For this purpose, the absorption channel is connected to the expansion chamber in a manner that allows the passage of liquid.

The absorption channel can be delimited at east partially by the closure part of the second damper. This greatly simplifies the production of the absorption channel.

The absorption channel can be surrounded radially on the outside by the channel part of the second damper. Owing to the integration of the absorption channel into the second damper, the hydraulic mount has a simple structure with very few parts and can be manufactured very cost-effectively. Therefore, there is no need for separate parts to provide an absorption function,

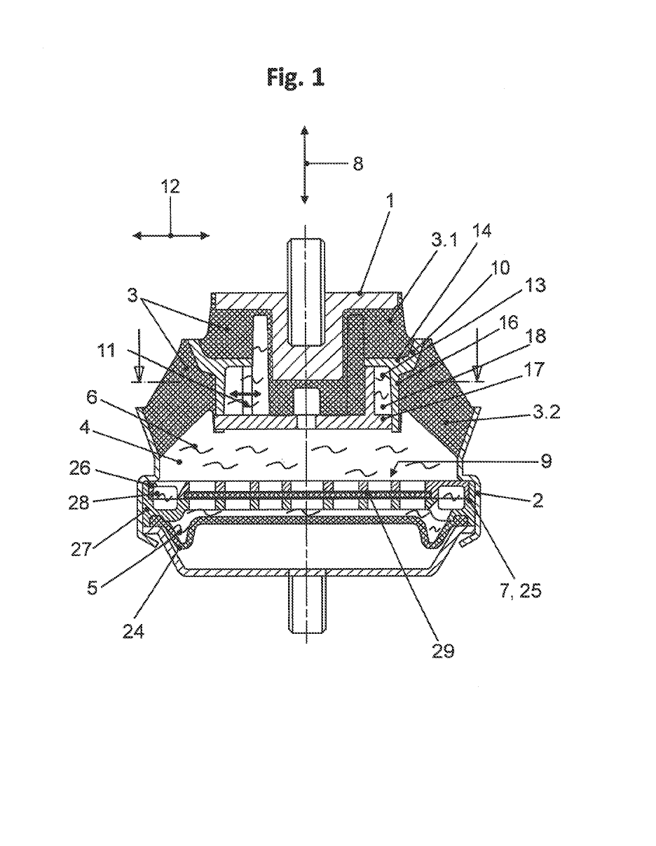

FIGS. 1 to 20 show ten embodiments of a hydraulic mount that are used as engine bearings and that comprise a support bearing 1 and a seat 2, which are supported on each other by a spring element 3 that is shaped like a truncated cone. The spring element 3 comprises two partial spring elements 3.1, 3.2 that are connected to each other by an intermediate ring 10. The support bearing 1 and the seat 2 are each made of a metallic material, while the spring element 3 is made of an elastomeric material. In a variant, the support bearing 1 and the seat 2 can each be made of a plastic or can be in the form of a composite part. The hydraulic mount comprises an expansion chamber 4 and a compensation chamber 5, whereby the compensation chamber 5 is delimited on its side facing axially away from the expansion chamber 4 by a membrane 24 that essentially that takes up volume in a pressure-free manner and that is shaped like rolling bellows. The expansion chamber 4 and the compensation chamber 5 are each filled with damping fluid 6 and are physically separated from each other by the partition 7 in the axial direction 8. The partition 7 comprises the first damper 9 for damping axially introduced vibrations.

In the embodiments shown here, the partition 7 has a nozzle cage 25 with an upper nozzle disk 26 and a lower nozzle disk 27, whereby, in the area of their outer circumference, the two nozzle disks 26, 27 delimit a channel 28 for damping low-frequency high-amplitude vibrations. In the embodiments shown here, the first damper 9 is part of the partition 7.

Between the two nozzle disks 26, 27, there is an isolating membrane 29 that is made of an elastomeric material, that is exposed to damping fluid from the expansion chamber 4 and from the compensation chamber 5, and that is arranged so as to be elastically resilient between the nozzle disks 26, 27. The isolating membrane 29 has the task of isolating low-amplitude high-frequency vibrations. Such vibrations are generated, for example, by the gas forces and the mass forces of the engine.

In addition to their damping capacity in the axial direction 8, the hydraulic mounts have a damping capacity in at least one radial direction 12. This damping capacity in the radial direction 12 is achieved by the second damper 11, whereby the second damper 11 is arranged in the expansion chamber 4 and is attached to the intermediate ring 10.

In an embodiment, the dimensions of the hydraulic mount as well as the required installation space practically do not differ from hydraulic mounts with or without an intermediate ring by means of which only damping in the axial direction 8 can be achieved. Therefore, the hydraulic mount according to an embodiment of the invention has compact dimensions and a structure with very few parts, as a result of which it can be manufactured inexpensively.

In order to damp vibrations introduced in the radial direction 12, the support bearing 1 moves relative to the second damper 11 in the radial direction, thereby bringing about a back-and-forth movement of the damping fluid 13 in the damping channels 18, 19 of the second damper 11.

In each of the embodiments shown, the second damper 11 is closed off so as to be fluid-tight with respect to the expansion chamber 4 and to the damping fluid 6 located in it during proper use in normal operations.

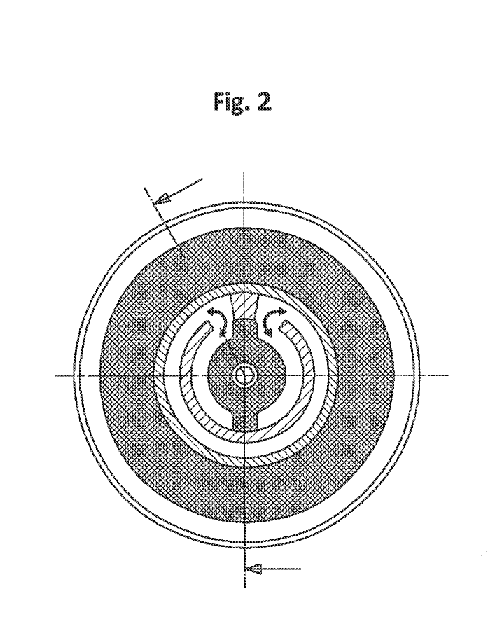

FIGS. 1 and 2 show a first embodiment. The second damper 11 comprises the channel part 16 and the closure part 17, whereby the closure part 17 closes off the damping channel 18 of the channel part 16 so as to be fluid-tight with respect to the expansion chamber 4, said damping channel 18 extending in the circumferential direction. The channel part 16 and the intermediate ring 10 are configured so as to make a transition from one to the other as a single piece and are made of the same material.

FIG. 2 shows across section through the hydraulic mount of FIG. 1. The damping channel extends once in the circumferential direction.

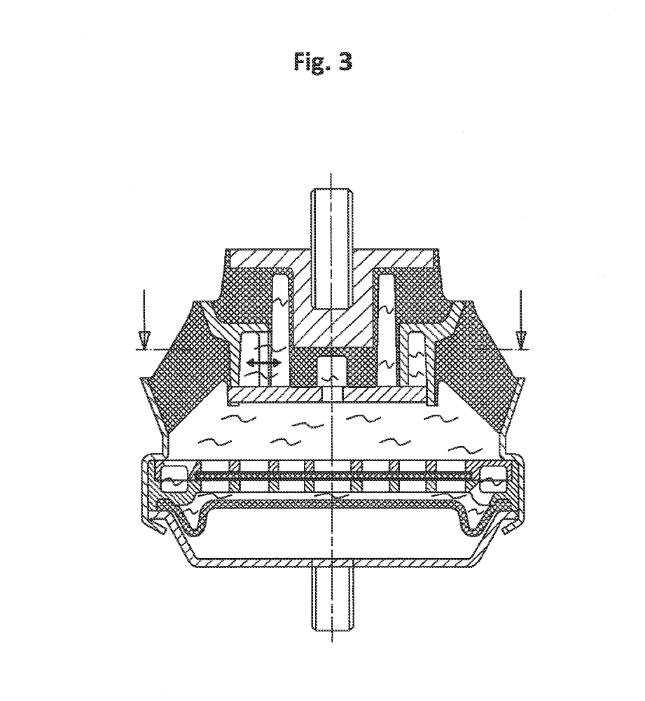

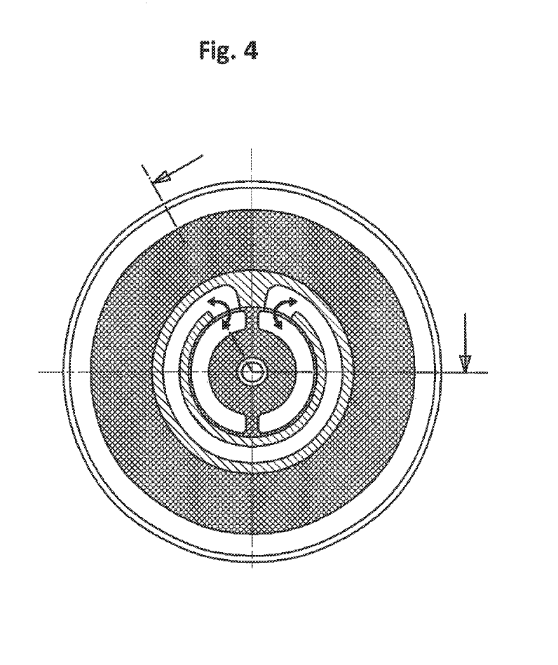

FIGS. 3 and 4 show a second embodiment of the hydraulic mount, which is similar to the embodiment of FIGS. 1 and 2. Here, too, the second damper 11 comprises a channel part 16 and a closure part 17, but they are designed differently from those of the first embodiment of FIGS. 1 and 2. The channel part 16 delimits the damping channel 18 in the radial direction on the inside and outside, whereby the damping channel 18 is closed on its face that is axially facing the expansion chamber 4 by the closure part 17.

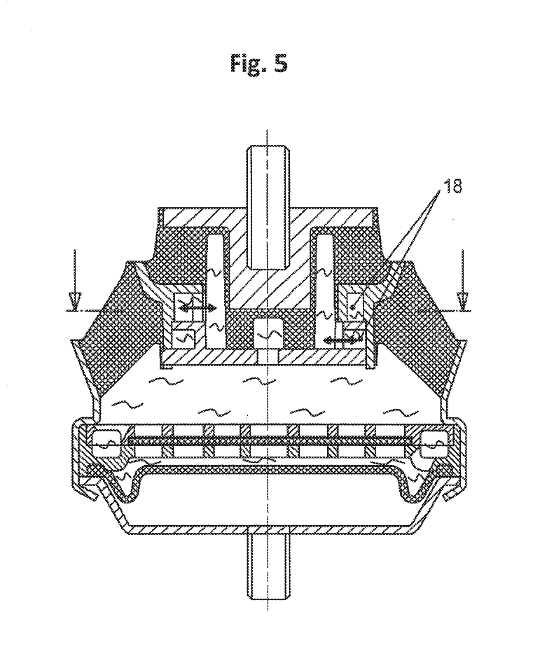

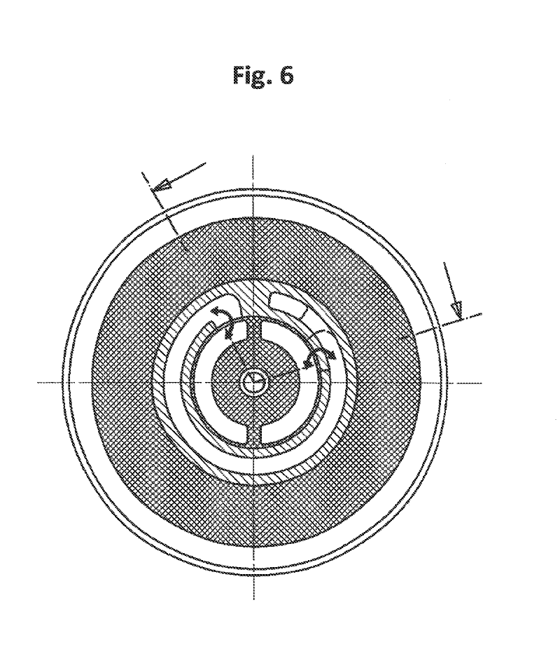

FIGS. 5 and 6 show a third embodiment of the hydraulic mount that differs from the two embodiments described above mainly in that the second damper 11 has an especially long damping channel 18 that is configured so as to be helical and bi-level in the axial direction 8. Like in the second embodiment according to FIGS. 3 and 4, the closure part 17 closes off the face of the damping channel 18 axially in the direction of the expansion chamber 4.

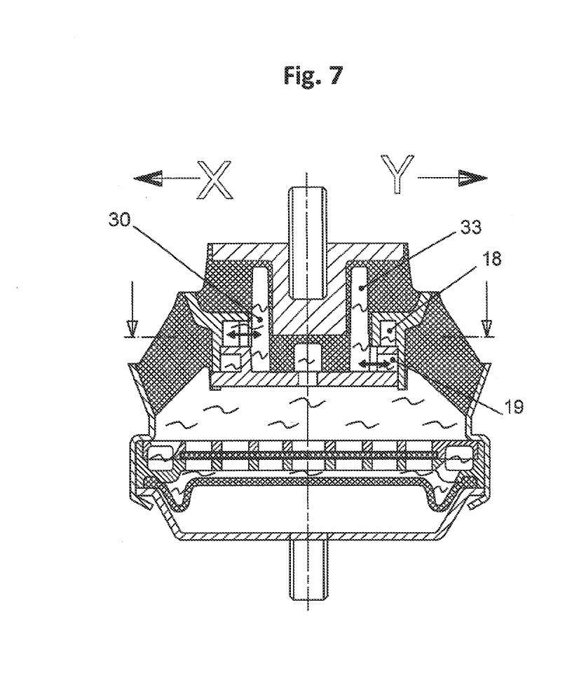

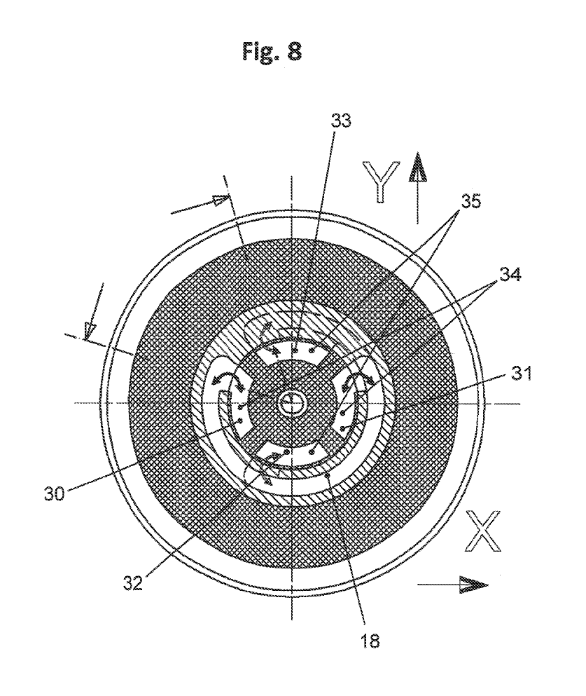

FIGS. 7 and 8 show a fourth embodiment of the hydraulic mount that differs from that of the third embodiment of FIGS. 5 and 6 mainly in that the second damper comprises two damping channels 18, 19 that are arranged adjacent to each other in the axial direction 8 and that are separated from each other so as to be fluid-tight. As a result, the second damper has four chambers 30, 31; 32, 33 that form the pairs of chambers 34, 35. Due to such an embodiment, it is advantageous that the position of the pairs of chambers 34, 35 of each damping channel 18, 19 can be arranged in such a way that damping in different radial directions X, Y can be achieved.

FIG. 8 shows a cross section through the hydraulic mount of FIG. 7. In this view, it can be seen that the chambers 30, 31; 32, 33 of the pairs of chambers 34, 35 are arranged offset with respect to each other by 90°, so that vibrations introduced radially into the hydraulic mount, as shown here in the X-direction and in the Y-direction, can be damped.

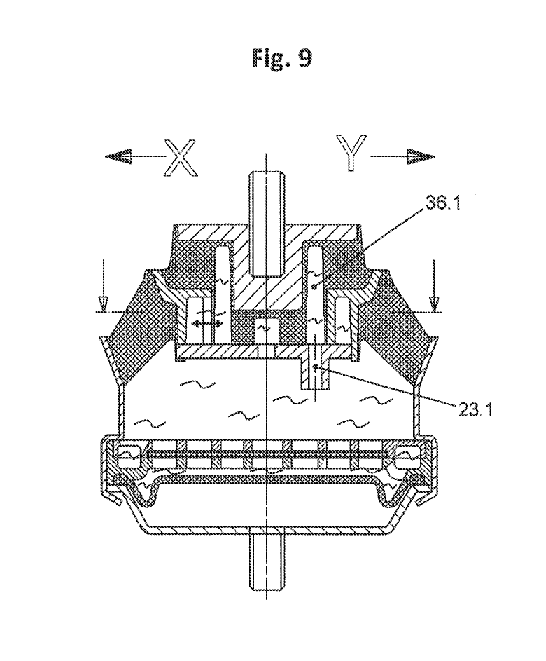

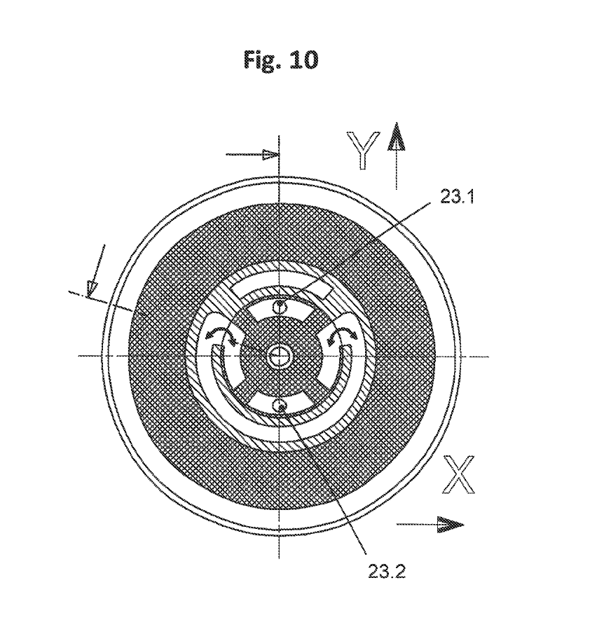

FIGS. 9 and 10 show a fifth embodiment. The hydraulic mount has, in addition to the first and second dampers 9, 11, at least one absorption channel 23, here two absorption channels 23.1, 23.2 by means of which, for instance, vibrations of the type generated when an internal combustion engine is started up can be absorbed. The absorption channels 23.1, 23.2 are integrated into the closure part 17 of the second damper 11 and they connect the absorption chamber 36 to the expansion chamber 4 in a manner that allows the passage of liquid.

In the X--direction, vibration is damped by the second damper 11, while in the Y-direction, vibration is damped by the chambers 36.1 and 23.1 with 36.2 and 23.2.

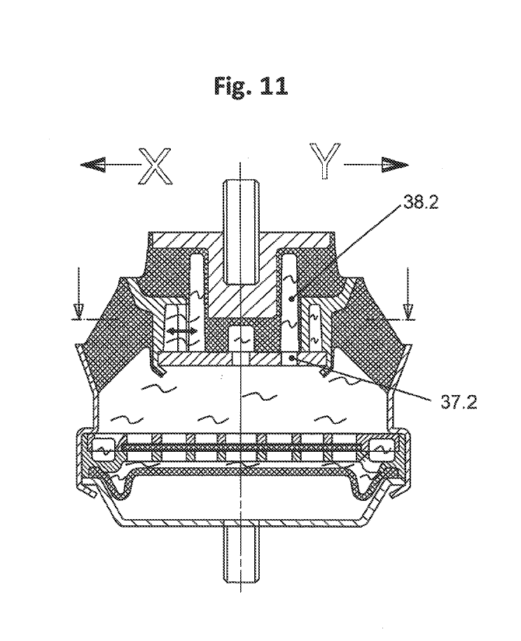

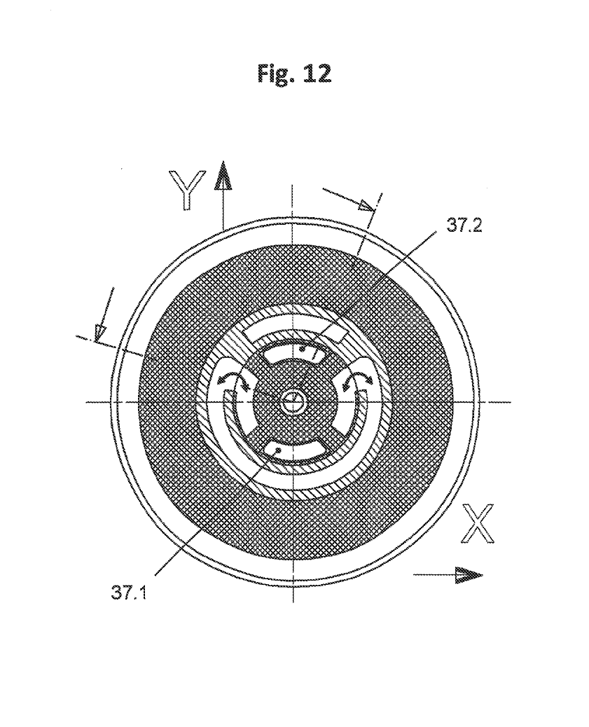

FIGS. 11 and 12 show a sixth embodiment, which is similar to the fifth embodiment of FIGS. 9 and 10. The closure part 17 additionally has a recess 37 that opens up into another chamber 38. Here, it is advantageous that the damping is minimized in the radial Y-direction, since the Y-chambers 38.1, 38.2 allow the damping fluid to flow unhindered through the large recesses 37.1, 37.2 into the chamber 4.

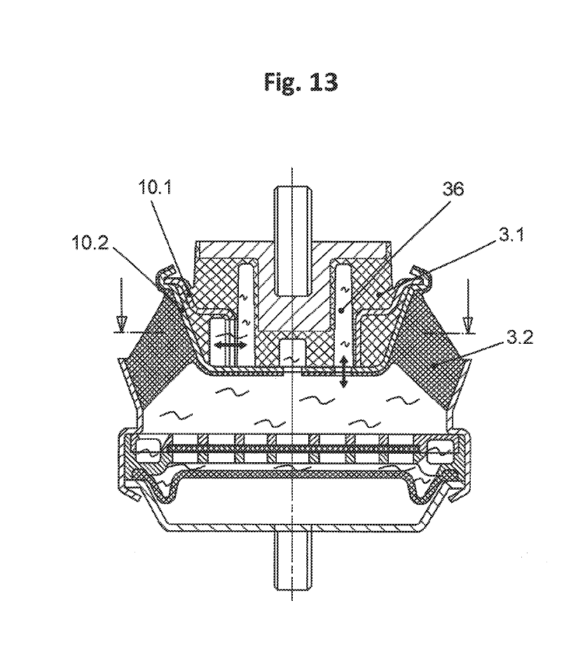

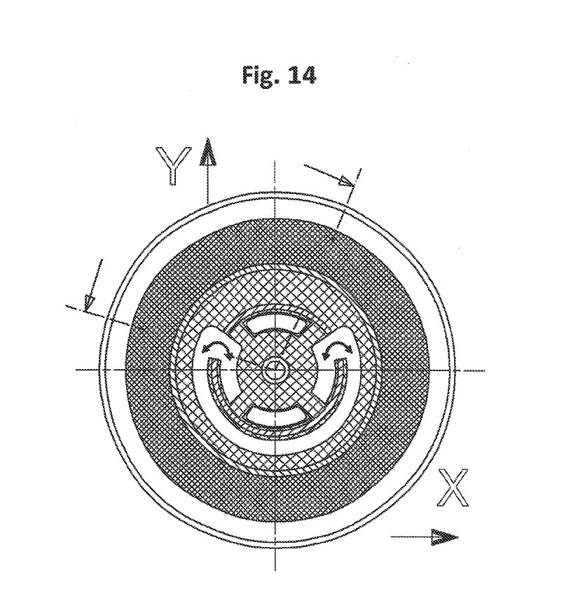

FIGS. 13 and 14 show a seventh embodiment in which a two-part intermediate ring 10.1, 10.2 is arranged between the two partial spring elements 3.1, 3.2. The two-part intermediate ring 10.1, 10.2 constitutes the second damper 11, whereby the function of the hydraulic mount corresponds essentially to the function of the hydraulic mount of FIGS. 11 and 12.

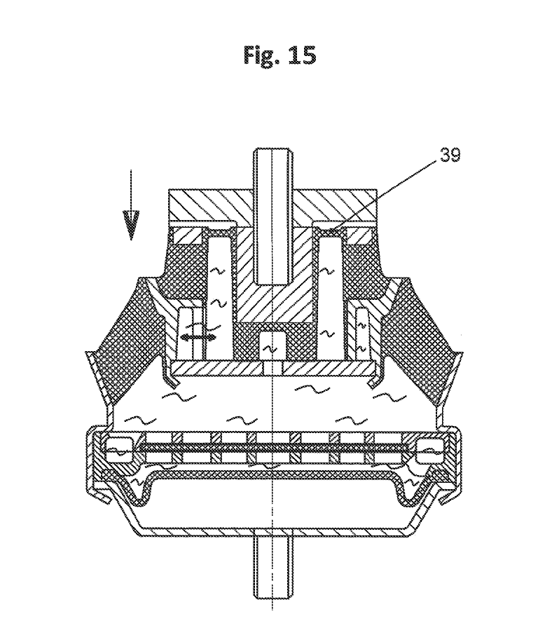

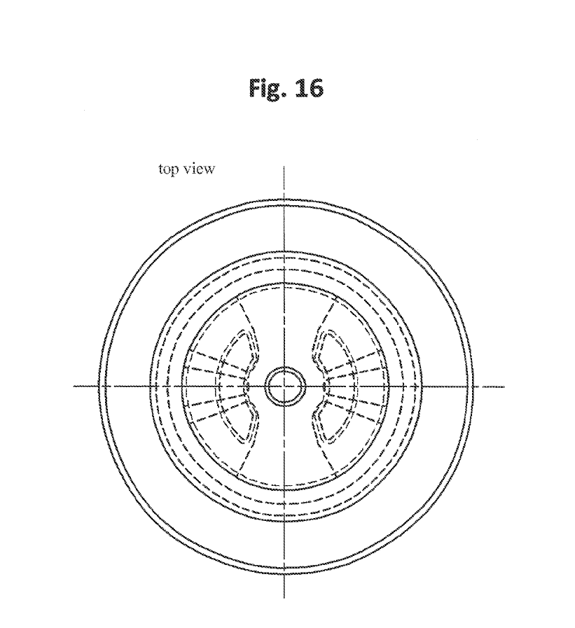

FIGS. 15 and 16 show an eighth embodiment of the hydraulic mount. In contrast to the previously described embodiments, the second damper 11 additionally comprises an uncoupling membrane 39 that delimits the pair of chambers of the second damper 11 in the axial direction 8 on the one hand, and that is exposed to the ambient pressure of the hydraulic mount in the axial direction 8 on the other hand. The uncoupling membrane 39 makes it possible to isolate higher-frequency, low-amplitude vibrations that are introduced into the hydraulic mount in the radial direction. The function of the uncoupling membrane 39 has a positive impact during the operation of the hydraulic mount especially when the radial damping system hardens dynamically and, at the same time, when excitations from the gas forces and the mass forces have to be uncoupled in the lengthwise or crosswise direction of the vehicle.

FIG. 16 shows a top view of the hydraulic mount of FIG. 15.

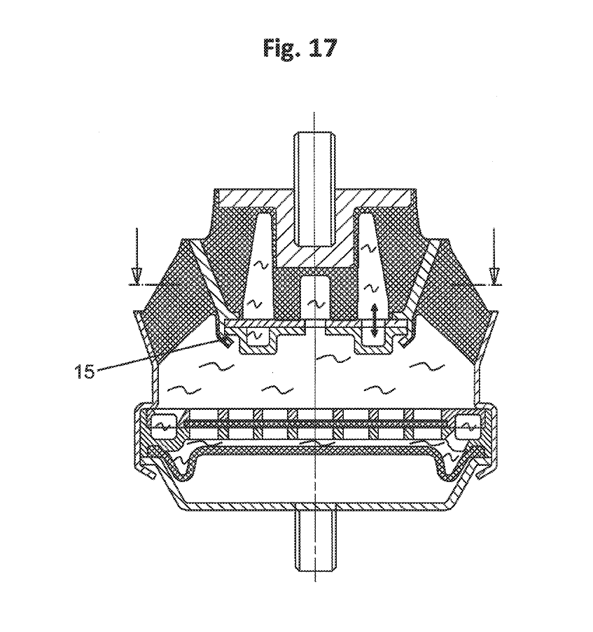

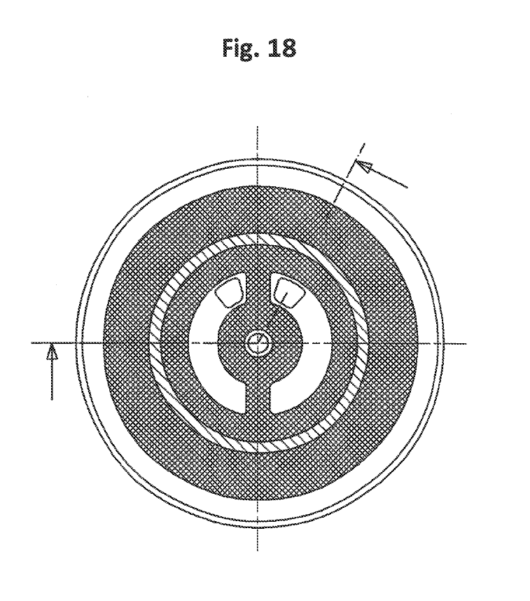

FIGS. 17 and 18 show a ninth embodiment of the hydraulic mount that differs from the hydraulic mounts described above in that the intermediate ring 10 has a holding means 15 on its inner circumferential side 14 that is arranged in the expansion chamber 4, that is configured as a holding claw, and that holds the second damper 11. Here, it is advantageous that the holding means 15 can hold second dampers 11 that have different designs and functions. As a result, different second dampers can be combined with an otherwise identical hydraulic mount. Such a hydraulic mount can be adapted especially easily and effectively to the particular circumstances of a given application case.

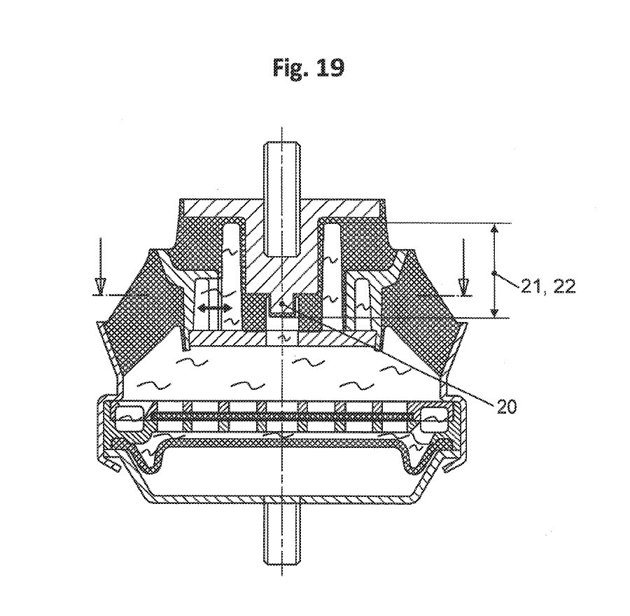

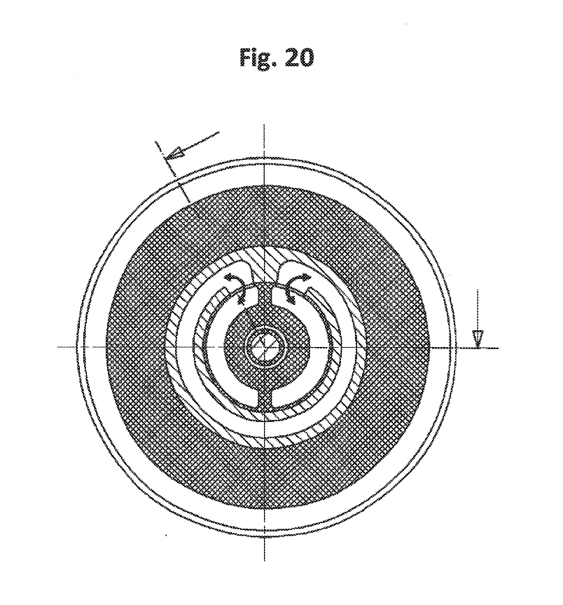

FIGS. 19 and 20 show a tenth embodiment of the hydraulic mount that is essentially the same as the second embodiment of FIGS. 3 and 4. As in previously described embodiments, the support bearing 1 is configured so as to be essentially T-shaped as seen in the lengthwise section of the hydraulic mount, but it additionally has a catch 20 that extends in the axial direction. The support bearing 1 and the catch 20 together have an axial extension 21 that corresponds essentially to the axial extension 22 of the second damper 11. As a result, the transmission of radially introduced vibrations to the second damper 11 is especially direct.

### List of Reference Numerals

1 support bearing
2 seat
3 spring element
3.1 first partial spring element
3.2 second partial spring element
4 expansion chamber
5 compensation chamber
6 damping fluid in 9
7 partition
8 axial direction
9 first damper
10 intermediate ring
11 second damper
12 radial direction
13 damping fluid in 11
14 inner circumferential side of 10
15 holding means
16 channel part
17 closure part
18 first damping channel
19 second damping channel
20 catch
21 axial extension of 1 and 20
22 axial extension of 11
23 absorption channel
23.1 absorption channel
23.2 absorption channel
24 membrane
25 nozzle cage
26 upper nozzle disk
27 lower nozzle disk
28 channel
29 isolating membrane
30 chamber
31 chamber
32 chamber
33 chamber
34 pair of chambers (30, 31)
35 pair of chambers (32, 33)
36.1 absorption chamber
36.2 absorption chamber
37.1 recess
37.2 recess
38.1 additional chamber
38.2, additional chamber
39 uncoupling membrane

1. A hydraulic mount, comprising:
a support bearing;
a seat;
at least a first and a second partial spring element each formed from an elastomeric material and connected to each other via an intermediate ring, the spring elements supporting the support bearing and the seat on each other and having essentially a truncated cone-like shape;
an expansion chamber and a compensation chamber each filled with a first damping fluid, the chambers being physically separated from each other, in an axial direction, by a partition and being connected to each other, in a manner that allows passage of liquid, by a first damper configured to dampen vibrations introduced in the axial direction; and
a second damper disposed in the expansion chamber and configured to dampen vibrations introduced in a radial direction, the intermediate ring and the second damper transitioning from one to the other.

2. The hydraulic mount according to claim 1, wherein the second damper is filled with a second damping fluid and is closed off so as to be fluid-tight with respect to the expansion chamber.

3. The hydraulic mount according to claim 1, wherein he intermediate ring includes a holding means disposed at an inner circumferential side of the intermediate ring in the expansion chamber and connected to the second damper.

4. The hydraulic mount according to claim 3, wherein the holding means is configured as a holding claw that is positively or non-positively connected to the second damper.

5. The hydraulic mount according to claim 1, wherein the intermediate ring and the second damper transition from one to the other as a single piece.

6. The hydraulic mount according to claim 1 wherein the second damper includes a channel part and a closure part configured to delimit at least one damping channel of the second damper.

7. The hydraulic mount according to claim 6, wherein the at least one damping channel is configured, in the axial direction, as a helical and a bi-level damping channel.

8. The hydraulic mount according to claim 6, wherein the second damper includes an additional damping channel, the damping channels being separated from each other so as to be fluid-tight and disposed adjacent to each other in the axial direction.

9. The hydraulic mount according to claim 1, wherein the support bearing is essentially T-shaped in a lengthwise section of the hydraulic mount.

10. The hydraulic mount according to claim 1, wherein the support bearing includes a catch extending in the axial direction toward the expansion chamber such that the support bearing and the catch together have an axial extension that corresponds essentially to an axial extension of the second damper,

11. The hydraulic mount according to claim 1, wherein the support bearing includes a catch extending in the axial direction toward the expansion chamber, the support bearing and the catch transitioning from one to the other as a single piece.

12. The hydraulic mount according to claim 1, further comprising an absorption channel disposed in the expansion chamber.

13. The hydraulic mount according to claim 12, wherein the absorption channel is delimited at least partially by a closure part of the second damper.

14. The hydraulic mount according to claim 12 or 13, wherein the absorption channel is surrounded radially by a channel part of the second damper.
